(19) United States
(12) Patent Application Publication
(10) Pub. No.: US 2009/0225351 A1
(43) Pub. Date: Sep. 10, 2009

(54) METHODS FOR MANAGING DIGITAL IMAGES AND SYSTEMS THEREOF

(75) Inventor: John Lacagnina, Rochester, NY (US)

Correspondence Address: NIXON PEABODY LLP - PATENT GROUP, 1100 CLINTON SQUARE, ROCHESTER, NY, 14604, US

(73) Assignee: COLORCENTRIC CORPORATION, Rochester, NY (US)

(21) Appl. No.: 12/248,997

(22) Filed: Oct. 10, 2008

Related U.S. Application Data
(60) Provisional application No. 60/998,296, filed on Oct. 10, 2007.

(51) Int. Cl. G06F 15/00

(52) U.S. Cl. 358/1.15

(57) ABSTRACT

A method, computer readable medium, and system that manages one or more captured images includes automatically receiving one or more images and at least one identifier from an image capture device. The received images with the associated identifier are stored and one or more hardcopies of one or more of the received images are provided based on the associated identifier.

This application claims the benefit of U.S. Provisional Patent Application Ser. No. 60/998,296, filed Oct. 10, 2007, which is herein incorporated by reference in its entirety.

### FIELD

This invention generally relates to methods and systems for managing images and, more particularly, to methods for automatically uploading, storing, and managing a display or printing of digital images in a variety of formats and systems thereof.

### BACKGROUND

Digital images can now easily be captured on a daily basis using a variety of different types of image capturing devices, such as digital cameras, web cameras, cell phones, and scanners. As a result, consumers are capturing larger and larger numbers of digital images than ever before.

Unfortunately, this increase in digital image capture has not resulted in a corresponding increase in obtaining traditional hardcopies of these digital images. This may be due to the fact that consumers have to change behaviors established over long periods of time from how images were obtained with conventional film photography. Traditionally, consumers simply dropped off or mailed in completed rolls of photographic film and then either received in the mail or picked up hardcopies of the images on the film. However, with digital images consumers have to learn how to print the captured digital images at their home or office or learn how to download and electronically transmit the captured digital images to an online retailer that publishes and then sends the hardcopies to the consumers.

Unfortunately, neither of these options is particularly desirable to most consumers. To print the hardcopies of captured digital images at home or in the office, consumers need to learn at least basic desktop publishing skills. This alone is enough to discourage at least a segment of these consumers from ever even trying to undertake printing of digital images. Another segment of consumers is willing to try and learn these skills, but still will struggle with learning sufficient skills to digitally manipulate captured images in order to obtain the best color renditions, color saturation, brightness and hue. Further, this segment of consumers also may be discouraged by the need for and cost of additional equipment and printing supplies necessary to print images.

Similarly, to learn how to download and electronically transmit the captured digital images to an online retailer, consumers also need to learn at least basic computing skills. Again, this alone is enough to discourage at least a segment of these consumers from ever even trying to undertake sending any digital images for printing. The segment of consumers that is willing to try and learn these skills, still may experience difficulties from time to time in doing so causing the consumer to download and transfer fewer images.

Additionally, hardcopies of digital images continue to suffer from many of the same problems hardcopies of images from photographic film experience. For example, like hardcopies of images from photographic film, digital images still lack appropriate notations to properly identify subjects, the location, the event and other information that would make the images more valuable to viewers and easier to pass on to friends and descendants. Additionally, like hardcopies of images from photographic film, digital images still struggle with providing appropriate layouts and finding other appropriate subject matter to combine with and enhance the captured images.

### SUMMARY

A method for managing one or more captured images in accordance with embodiments of the present invention includes automatically receiving one or more images and at least one identifier from an image capture device. The received images with the associated identifier are stored and one or more hardcopies of one or more of the received images are provided based on the associated identifier.

A computer readable medium having stored thereon instructions for managing one or more captured images in accordance with other embodiments of the present invention comprising machine executable code which when executed by at least one processor, causes the processor to perform steps including automatically receiving one or more images and at least one identifier from an image capture device. The received images with the associated identifier are stored and one or more hardcopies of one or more of the received images are provided based on the associated identifier.

A system that manages one or more captured images in accordance with other embodiments of the present invention includes a communication system, a storage system, and an image controller system. The communication system automatically receiving one or more images and at least one identifier from an image capture device; The storage system stores the received images with the associated identifier. The image controller system manages providing one or more hardcopies of one or more of the received images based on the associated identifier.

The present invention provides a number of advantages including providing an easier to use and more effective method and system for managing one or more captured images. With the present invention, an appropriate communication channel can automatically be identified, connected to, and utilized to transfer captured images for storage and processing. This dramatically simplifies the process for the operator of the digital camera.

Additionally, with the present invention the received images are safely stored and easily retrieved for either printing of hardcopies or viewing of soft copies of the digital images. The present invention also provides numerous publishing options, such as combining corresponding audio or text with the hardcopy of the image, identifying and combining appropriate templates for publishing the images together, and identifying and combining appropriate stock images with the hardcopies.

### BRIEF DESCRIPTION OF THE DRAWINGS

FIG. 1 is a block diagram of a system that manages one or more captured images in accordance with embodiments of the present invention; and

FIG. 2 is a flow chart of a method for managing one or more captured images in accordance with embodiments of the present invention.

### DETAILED DESCRIPTION

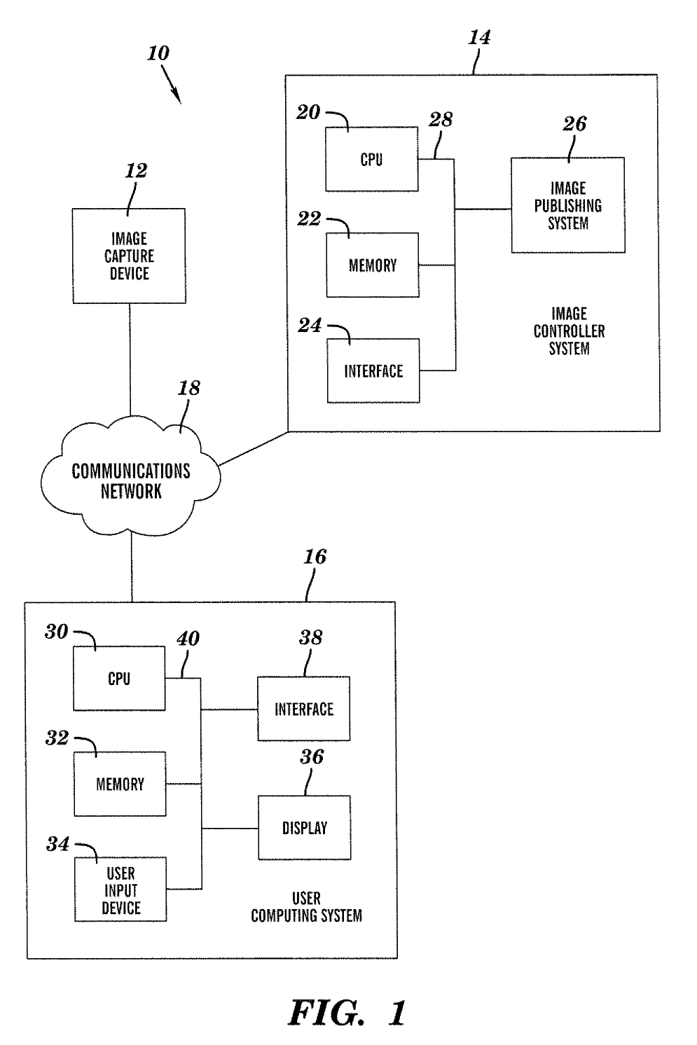

A system 10 that manages one or more captured images in accordance with embodiments of the present invention is illustrated in FIG. 1. The system 10 includes an image capture device 12, an image controller system 14, and a user computing system 16, although the system can include other types and numbers of systems, device, and elements connected in other manners. The present invention provides an easier to use and more effective method and system for managing one or more captured images.

Referring more specifically to FIG. 1, the image capture device 12 is a digital camera, although other types and numbers of image capturing devices can be used, such as a web camera, cell phone, or scanner by way of example only. The image capture device 12 can capture, store, and transfer captured digital images, although the image capture device can have other types and numbers of functions and can capture other types of images. The image capture device 12 includes an interface system that is used to identify and operatively couple to a communication network 18 to establish communications between the image capture device 12 and the image controller system 14 and the user computing system 16, although other types and numbers of communication networks or systems with other types and numbers of connections and configurations to other types and numbers of systems, devices, and components can be used. In this example, the communication network 18 is a wireless network, although other types and numbers of communication networks, such as a direct connection, a local area network, a wide area network, modems and phone lines each having their own communications protocols, can be used. The image capture device 12 also a location identification system, such as a global positioning system by way of example only, which can capture and record the location of the image capture device 12 each time an image is captured. Since the other components and operation of image capture devices are well known to those of ordinary skill in the art, they will not be described here.

The image controller system 14 receives, stores, manages the combination of audio or text with the images, manages providing hardcopies, manages the display of soft copies, and manages publication of the images using identified stock images and templates in a variety of formats, although the image controller system 14 can perform other types and numbers of functions and there may be other numbers of management systems. The image controller system 14 includes a central processing unit (CPU) or processor 20, a memory 22, an interface system 24, and an image publishing system 26 which are coupled together by a bus 28 or other link, although other numbers and types of systems, devices, and components in other configurations and locations can be used, such as having the image publishing system 26 as a separate system at another location by way of example only. The processor 20 executes a program of stored instructions for one or more aspects of the present invention as described herein. The memory 22 stores these programmed instructions for one or more aspects of the present invention as described herein as well as received images, stock images, templates, registration information that corresponds to received identifiers, audio, text, and other data, although some or all of the programmed instructions could be stored and/or executed elsewhere and some or all of this information could be stored at other locations, such as in one or more databases at one or more other locations by way of example only. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the image controller system 14. The interface system 24 is used to identify and operatively couple to a communication network 18 to establish communications between the image controller system 14 and the image capture device 12 and the user computing system 16, although other types and numbers of communication networks or systems with other types and numbers of connections and configurations to other types and numbers of systems, devices, and components can be used. The image publishing system 26 is used to print hardcopies of images, to combine audio with images, to combine text with images, to identify and use templates to print images, and to identify and combine stock images with received images being printed, although image publishing system 26 could have other types and numbers of functions.

The user computing system 16 is used to request hardcopies of stored images in a variety of formats and to view soft copies of stored images and stock images, although other types and numbers of systems could be used, such as having a plurality of user computing systems, and other types and numbers of functions can be performed by the user computing system. The user computing system 16 includes a central processing unit (CPU) or processor 30, a memory 32, user input device 34, a display 36, and an interface system 38, and which are coupled together by a bus 40 or other link, although the user computing system 16 can include other numbers and types of components, parts, devices, systems, and elements in other configurations. The processor 30 executes a program of stored instructions for one or more aspects of the present invention as described and illustrated herein, although the processor could execute other numbers and types of programmed instructions.

The memory 32 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory 22.

The user input device 34 is used to input selections, such as to input registration information about the operator of the image capture device or to select one or more of the images for viewing or printing, although the user input device 34 could be used to input other types of data and interact with other elements. The user input device 34 can include a computer keyboard and a computer mouse, although other types and numbers of user input devices can be used. The display 36 in each of the user computing system 16 is used to show data and information to the user, such as the fields for entering registration information and soft copies of stored images and stock images by way of example only. The display 36 can include a computer display screen, such as a CRT or LCD screen, although other types and numbers of displays could be used.

The interface system 30 is used to identify and operatively couple to and communicate between the user computing system 16 and image controller system 14 and the image capture device 12 over the communication network 18, although other types and numbers of communication networks or systems with again other types and numbers of connections and configurations to other types and numbers of systems, devices, and components can be used.

Although embodiments of the image controller system 14 and user computing system 16 are described and illustrated herein, the image controller system 14 and the user computing system 16 can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

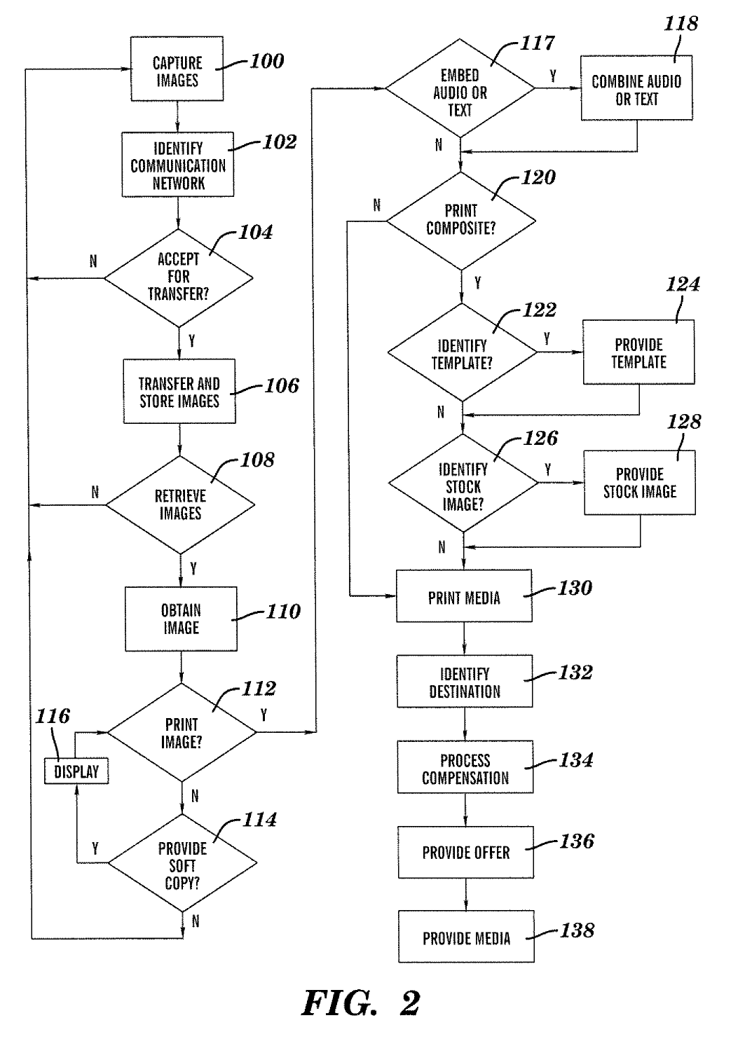

A method for managing one or more captured images in accordance with an exemplary embodiment will now be described with reference to FIGS. 1-2. Although in this particular example, the processing steps described herein are substantially executed by the image controller system 14 as described below, some or all of these steps can be executed by other systems, devices, or components, such as by the user computing system 16.

Initially, the operator of the image capture device 12 using the user computing system 16 provides registration information, such as the name and address of the operator and the type of image capture device by way of example only, to the image controller system 14 for storage in memory 22, although other manners for providing and storing this registration information can be used.

In step 100, the image capture device 12 captures one or more images, although the image capture device 12 can capture other types and amounts of data, such as audio which accompanies a captured image or input text which accompanies a captured image by way of example only. The image capture device 12 also embeds an identifier with the data for each captured image that associates the image with the operator of this image capture device 12 along with the date and location of the image capture device 12, although other types and amounts of data could be combined with some, all or none of the captured images. The captured images along with any other data initially are stored in the image capture device 12 in manners well known to those to ordinary skill in the art.

In step 102, the image capture device 102 monitors for and identifies if there are any available communication networks, although other manners and systems or device for identifying communication networks can be used.

In step 104, the image capture device 104 determines whether to accept one of the identified communication networks to couple to and transfer images and other related data to the image controller system 14, although manners for determining when and how to connect to image controller system 14 or other systems and devices can be used. If in step 104, the image capture device 104 does not identify an available communication network or accept one of the identified communication networks, then the No branch is taken back to step 100 as described earlier. If in step 104, the image capture device 104 does accept one of the identified communication networks, then the yes branch is taken back to step 106.

In step 106, the image capture device 104 transfers the one or more captured images and any other related data, such as the embedded identifier with the location at which each image was captured over the communications network 18 to the image controller system 14, although manners of transferring this and other amounts and types of data can be used. The image controller system 14 reads the identifier for the one or more received images and stores the images and any other received data in memory 22, although the data could be stored at other locations in other manners.

In step 108, the image controller system 14 determines whether a request to retrieve one or more of the stored images is received from the user computing system 16, although requests to retrieve one or more of the stored images can be received from other types and numbers of devices. If the image controller system 14 determines a request to retrieve one or more of the stored images has not been received, then the No branch is taken back to step 100 as described earlier. If the image controller system 14 determines a request to retrieve one or more of the stored images has been received, then the Yes branch is taken back to step 110.

In step 110, the image controller system 14 retrieves one or more of the stored images from memory 22 associated with an identifier which corresponds to the image identification information in the received request, although other manners for identifying and retrieving the stored images can be used.

In step 112, the image controller system 14 determines whether the one or more retrieved images should be printed on a media based on information in the received request to retrieve the one or more images, although the image controller system 14 could determine whether to print the images in other manners and based on other information. For example, the image controller system 14 could query and wait for a response from the user computing system 16 which submitted the request to retrieve the images if printing the one or more retrieved images is desired. If the image controller system 14 determines the one or more retrieved images should not be printed, then the No branch is taken to step 114.

In step 114, the image controller system 14 determines whether the one or more retrieved images should be provided for display to the user computing system 16 that submitted the request for the one or more retrieved images, although the image controller system 14 could determine whether to provide the one or more retrieved images for display in other manners and for delivery to one or more other locations. If the image controller system 14 determines the one or more retrieved images should be provided for display, then the Yes branch is taken to step 116. In step 116, the one or more retrieved images are provided by the image controller system 14 to the user computing system 16 for a soft display on the display 36, although again the image controller system 14 could provide the one or more retrieved images to one or more other locations. If the image controller system 14 determines the one or more retrieved images should not be provided for display, then the No branch is taken to back to step 100 as described earlier. If in step 112 the image controller system 14 determines the one or more retrieved images should be printed, then the Yes branch is taken to step 116.

In step 116, the image controller system 14 determines whether there is any audio or text associated with any of the one or more retrieved images and if that audio or text should be combined with the corresponding one or more retrieved images, although the image controller system 14 could whether other types and amounts of data are associated with the one or more retrieved images and should be combined with the corresponding one or more retrieved images. If the image controller system 14 determines there is audio or text associated with any of the one or more retrieved images and that audio or text should be combined with the corresponding one or more retrieved images, then the Yes branch is taken to step 118.

In step 118, the image controller system 14 embeds any audio associated with the corresponding one or more retrieved images in a medium on the media on which the corresponding one or more retrieved images will be printed and prints any text on the medium on the media on which the corresponding one or more retrieved images will be printed, although other manners for combining the audio or text with the one or more retrieved images could be used. By way of example only, a toddler's laughter may be captured in an audio clip at the time one of the retrieved images was captured or at a later time later and then embedded in a medium, such as microchips, magnetic stripes, or any other form of encoding capable of storing playable data for the audio clip, on the media on which the associated one of the retrieved images will be printed. Additionally, the one of the retrieved images which corresponds with the audio or text could be printed on the media first before the audio or text is combined with the media.

If in step 116 the image controller system 14 determines either there is no audio or text associated with any of the one or more retrieved images or that any available audio or text should not be combined with the corresponding one or more retrieved images, then the No branch is taken to step 120. In step 120, the image controller system 14 determines whether there is a request from the user computing system 16 to produce a composite printing of a plurality of the one or more retrieved images, such as a book, album, calendar, or postcard by way of example only, although the image controller system 14 could make this determination in other manners and based on input from other sources. If the image controller system 14 determines there is a request to produce a composite printing then the Yes branch is taken to step 122.

In step 122, the image controller system 14 determines whether there is a request from the user computing system 16 to identify one or more templates to produce the composite printing, although the image controller system 14 could make this determination in other manners and based on input from other sources. If the image controller system 14 determines there is a request to identify one or more templates, then the Yes branch is taken to step 124. In step 124, the image controller system 14 identifies one or more templates which are appropriate based on the one or more retrieved images and the type of composite printing requested by the user computing system 16, although other manners for identifying and obtaining a selection of the one or more templates could be used. For example, the image controller system 14 could provide one or more template options to and wait for a selection response from the user computing system 16 which submitted the request to retrieve the images. If the image controller system 14 determines there is a no request to identify one or more templates, then the No branch is taken to step 126.

In step 126, the image controller system 14 determines whether there is a request from the user computing system 16 to identify one or more stock images to use with the one or more retrieved images to produce the composite printing, although the image controller system 14 could make this determination in other manners and based on input from other sources. In step 128, the image controller system 14 identifies one or more stock images which are appropriate to be combined with the one or more retrieved images based on the location information at which the one or more retrieved images were captured, although other manners for identifying and obtaining a selection of the one or more stock images could be used. For example, the image controller system 14 could provide one or more stock image options to and wait for a selection response from the user computing system 16 which submitted the request to retrieve the images. By way of example only, the one or more retrieved images may have been captured at the Great Wall of China. The identifier with the captured images in this example includes the obtained location information. The image controller system 14 processes this obtained location information for the one or more retrieve images and can identify and provide one or more stock images of the Great Wall of China and/or other locations of interest in China which could be combined with the one or more retrieved images. Additionally, the image controller system 14 could provide the one or more identified stock image options to and wait for a selection response from the user computing system 16 which submitted the request to retrieve the images.

If in step 126 the image controller system 14 determines there is a no request to identify one or more stock images, then the No branch is taken to step 130. Additionally, if back in step 120 the image controller system 14 determines there is a no request to produce a composite printing then the No branch is taken to step 130.

In step 130, the image controller system 14 prints the one or more retrieved images on the media in the particular format which was selected. For example, if a printing composite was not selected, then the one or more retrieved images could be individually printed on media along with any identified audio or text which was combined with the media. Additionally, by way of example the printed media could be framed. Further, in another example, if a printing composite was selected, then any of the identified templates can be used to print the one or more images in a composite, such as a book, album, or calendar. In another example, if a printing composite was selected, then any of the identified stock images can be combined with and printed in a composite. Even further, the image controller system 14 could provide the composite to the user computing system 16 for review, modification, and approval before printing.

In step 132, the image controller system 14 identifies the one or more destinations to provide the printed media based on the registration information in the identifier associated with the one or more retrieved images, although other manners for determining the one or more destinations to provide the printed media can be used. For example, the image controller system 14 could query and wait for a response from the user computing system 16 about the one or more destinations for the printed media.

In step 134, the image controller system 14 processes the compensation received from the user computing system 16 for the printing and receipt of the media with the one or more retrieved images, although other manners for handling compensation related to the operations described herein can be used. Since steps for processing compensation are well known to those of ordinary skill in the art they will not be described in detail here.

In step 136, the image controller system 14 may optionally offer the user computing system 16 the image capture device 12 for free or at a reduced price in exchange for a purchase of at least one of a subscription to use the image capture device 12 for a first period of time and a commitment to purchase a first number of the hardcopies of captured images, although other types and numbers of offers can be made to other types and numbers of entities. For example, the image controller system 14 may optionally offer to sell the image capture device 12 at a set price, such as the retail price by way of example only, along with a free or reduced price subscription for hardcopies of captured images for a first period of time or a commitment to provide a first number of the hardcopies of captured images for free or at a reduce price. The image controller system 14 will monitor for and process the response to the offer in manners well known to those of ordinary skill in the art.

In step 138, the image controller system 14 provides the printed media by regular mail to the one or more identified destinations, although other manners for delivering the printed media and other formats for providing printed media could be used.

Accordingly, as illustrated and described herein the present invention provides an easier to use and more effective method and system for managing one or more captured images.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A method for managing one or more captured images, the method comprising:
automatically receiving one or more images and at least one identifier from an image capture device;
storing the received images with the associated identifier; and
providing one or more hardcopies of one or more of the received images based on the associated identifier.

2. The method as set forth in claim 1 wherein the automatically receiving is further based on receiving one or more images and at least one identifier from an image capture device over one of one or more communication networks identified to be accessible by and accepted by the image capture device.

3. The method as set forth in claim 1 further comprising:
retrieving one or more of the stored images; and
providing the retrieved one or more of the stored images for display.

4. The method as set forth in claim 1 wherein the automatically receiving further comprises receiving at least one of audio and text associated with one or more of the received images.

5. The method as set forth in claim 4 wherein the providing one or more hardcopies further comprises embedding in a readable format the at least one of the audio and the text with the one or more hardcopies.

6. The method as set forth in claim 1 wherein the at least one identifier is encoded with one or more of the received images.

7. The method as set forth in claim 1 wherein the providing one or more hardcopies further comprises identifying one or more addresses from the at least one identifier to provide the one or more hardcopies of one or more of the received images.

8. The method as set forth in claim 1 wherein the providing at least one hardcopy further comprises:
combining a plurality of the one or more received images into one printed media; and
providing the one printed media.

9. The method as set forth in claim 8 wherein the combining further comprises:
identifying one or more templates based on the one or more received images; and
combining the plurality of the one or more received images with the one or more identified templates to form the one printed media.

10. The method as set forth in claim 8 wherein the combining further comprises:
identifying one or more stock images based on the one or more received images; and
combining the plurality of the one or more received images with the one or more stock images to form the one printed media.

11. The method as set forth in claim 10 wherein the identifying further comprises obtaining location information from the identifier with the one or more received images, wherein the identifying one or more stock images is based on the obtained location information.

12. The method as set forth in claim 1 further comprising receiving compensation for one or more of the hardcopies.

13. The method as set forth in claim 1 further comprising providing an offer for the image capture device in exchange for at least one of a subscription to use the image capture device for a first period of time and a commitment to purchase a first number of the hardcopies.

14. A computer readable medium having stored thereon instructions for managing one or more captured images comprising machine executable code which when executed by at least one processor, causes the processor to perform steps comprising:
automatically receiving one or more images and at least one identifier from an image capture device;
storing the received images with the associated identifier; and
providing one or more hardcopies of one or more of the received images based on the associated identifier.

15. The medium as set forth in claim 14 wherein the automatically receiving is further based on receiving one or more images and at least one identifier from an image capture device over one of one or more communication networks identified to be accessible by and accepted by the image capture device.

16. The medium as set forth in claim 14 further comprising:
retrieving one or more of the stored images; and
providing the retrieved one or more of the stored images for display.

17. The medium as set forth in claim 14 wherein the automatically receiving further comprises receiving at least one of audio and text associated with one or more of the received images.

18. The medium as set forth in claim 17 wherein the providing one or more hardcopies further comprises embedding in a readable format the at least one of the audio and the text with the one or more hardcopies.

19. The medium as set forth in claim 14 wherein the at least one identifier is encoded with one or more of the received images.

20. The medium as set forth in claim 14 wherein the providing one or more hardcopies further comprises identifying one or more addresses from the at least one identifier to provide the one or more hardcopies of one or more of the received images.

21. The medium as set forth in claim 14 wherein the providing at least one hardcopy further comprises:
combining a plurality of the one or more received images into one printed media; and
providing the one printed media.

22. The medium as set forth in claim 21 wherein the combining further comprises:
identifying one or more templates based on the one or more received images; and
combining the plurality of the one or more received images with the one or more identified templates to form the one printed media.

23. The medium as set forth in claim 21 wherein the combining further comprises:
identifying one or more stock images based on the one or more received images; and
combining the plurality of the one or more received images with the one or more stock images to form the one printed media.

24. The medium as set forth in claim 23 wherein the identifying further comprises obtaining location information from the identifier with the one or more received images, wherein the identifying one or more stock images is based on the obtained location information.

25. The medium as set forth in claim 14 further comprising receiving compensation for one or more of the hardcopies.

26. The medium as set forth in claim 14 further comprising providing an offer for the image capture device in exchange for at least one of a subscription to use the image capture device for a first period of time and a commitment to purchase a first number of the hardcopies.

27. A system that manages one or more captured images, the system comprising:
a communication system which automatically receiving one or more images and at least one identifier from an image capture device;
a storage system that stores the received images with the associated identifier; and
an image controller system that manages providing one or more hardcopies of one or more of the received images based on the associated identifier.

28. The system as set forth in claim 27 wherein the communication system automatically receives the one or more images and the identifier from the image capture device over one of one or more communication networks identified to be accessible by and accepted by the image capture device.

29. The system as set forth in claim 27 wherein the image controller system retrieves one or more of the stored images and provides the retrieved one or more of the stored images for display.

30. The system as set forth in claim 27 wherein the communication system automatically receives at least one of audio and text associated with one or more of the received images.

31. The system as set forth in claim 30 wherein the image controller system embeds in a readable format the at least one of the audio and the text with the one or more hardcopies.

32. The system as set forth in claim 27 wherein the communication system automatically receives the at least one identifier encoded with one or more of the received images.

33. The system as set forth in claim 27 wherein the image controller system identifies one or more addresses from the at least one identifier to provide the one or more hardcopies of one or more of the received images.

34. The system as set forth in claim 27 wherein the image controller system combines a plurality of the one or more received images into one printed media and provides the one printed media.

35. The system as set forth in claim 34 wherein the image controller system identifies one or more templates based on the one or more received images and combines the plurality of the one or more received images with the one or more identified templates to form the one printed media.

36. The system as set forth in claim 34 wherein the image controller system identifies one or more stock images based on the one or more received images and combines the plurality of the one or more received images with the one or more stock images to form the one printed media.

37. The system as set forth in claim 36 wherein the image controller system obtains location information from the identifier with the one or more received images, wherein the image controller system identifies one or more stock images based on the obtained location information.

38. The system as set forth in claim 27 wherein the image controller system processes a receipt of compensation for one or more of the hardcopies.

39. The system as set forth in claim 27 wherein the image controller system manages providing an offer for the image capture device in exchange for at least one of a subscription to use the image capture device for a first period of time and a commitment to purchase a first number of the hardcopies.
